(19) United States
(12) Patent Application Publication
(10) Pub. No.: US 2023/0284358 A1
(43) Pub. Date: Sep. 7, 2023

(54) Domestic Animal Path and Task Illumination System

(71) Applicants: Joshua Aaron Heater, Washington, UT (US); Edwin Joseph Heater, New Meadows, ID (US)

(72) Inventors: Joshua Aaron Heater, Washington, UT (US); Edwin Joseph Heater, New Meadows, ID (US)

(21) Appl. No.: 18/114,246

(22) Filed: Feb. 25, 2023

Related U.S. Application Data
(60) Provisional application No. 63/317,039, filed on Mar. 6, 2022.

(51) Int. Cl. H05B 47/115; H05B 47/11; A01K 29/00

(52) U.S. Cl. CPC H05B 47/115; H05B 47/11; A01K 29/005

(57) ABSTRACT

An illumination system (1) providing various apparatus and methods to facilitate task (8) and path (7) illumination for domestic animals (3). Particular embodiments of the invention comprise a light sensor (5) and a motion sensor (2) to actuate light dispersion (4) to facilitate illumination for domestic animals (3) during path (7), egress (11), and task (8) activities. Other embodiments of the invention include a power source utilizing solar (6), plug-in, or batteries. Other embodiments of the invention provide integrated and non-integrated solutions utilizing ceiling and wall mount orientation.

A motion activated illumination system to facilitate task and path illumination for domestic animals.

### BACKGROUND

There are a variety of motion activated illumination systems used to provide humans with increased visibility. This motion activated illumination systems include plug-in, solar powered, or battery powered. This motion activated illumination systems have been designed to illuminate when motion is detected to provide humans with increased safety and convenience in dark, or dimly illuminated areas. A significant problem can be that the motion activated illumination devices, as described, were not specifically designed for enhancing visibility for domestic animal path and task areas. Therefore, what is needed are techniques, uses or applications that go beyond the scope of the above mentioned human utilization.

Domestic animals have a necessity for increased visibility in dark or dimly illuminated path and task areas. Domestic animal path areas can be, but are not limited to walking, trotting, egress, and running areas. Domestic animal task areas can be, but are not limited to exercising, laying, standing, sleeping, sitting, feeding, drinking, defecating, urinating, and kenneling areas. When domestic animals fail to exhibit the intelligence required to activate a trigger to turn on or off illumination, it is necessary for the illumination systems to be motion activated. The illumination system will activate when the domestic animal enters the path or task area.

Specifically, the present invention relates to the use of motion activated illumination systems strategically designed and located to facilitate visibility for domestic animals in and around a dwelling.

Some domestic animals exhibit enhanced night vision, utilizing rod dominated retinas, which allows them better visual acuity in low light situations. Because of the enhanced night vision abilities of these domestic animals, many domestic animal caretakers incorrectly assume that domestic animals can see in the dark. The assumption that domestic animals can see in the dark can cause confusion for their caretakers, leading to lack of illumination in dark or dimly illuminated task and path areas for domestic animals. When illumination is not provided for a domestic animal in dark task and path areas, it may cause the domestic animal to refuse to move around, interact, or enter dark areas.

Utilizing motion activated plug-in, solar powered, or battery powered illumination systems allow domestic animal caretakers to provide lighting for path and task areas that the domestic animals frequently use when illuminated but refuse or are reluctant to use during times of darkness.

### SUMMARY OF THE INVENTION

A broad object of the invention can be to provide illumination systems and methods for illuminating path, task, and egress areas for indoor or outdoor domestic animals.

An object of the invention can be to provide and activate illumination of path, task, and egress areas for domestic animals when the motion of a domestic animal is detected. Another aspect of the invention can be that illumination of path, task, and egress areas for domestic animals is extinguished when no motion is detected.

Another aspect of the invention can be to provide illumination of path, task, and egress areas for domestic animals when a photocell detects low light levels and motion is detected. Conversely, an aspect of the invention can be to deactivate the illumination of path, task, and egress areas for domestic animals when a photocell detects high light levels.

An aspect of the invention can be to provide illumination of path, task, and egress areas for domestic animals within the light spectrum of 550-740(nm) so as to not disrupt the domestic animals' melatonin production.

An aspect of the invention can be to provide illumination of path, task, and egress areas for domestic animals within the light spectrum of 320-549(nm) so as to activate the domestic animals' melatonin production.

An aspect of the invention can be to provide illumination of path, task, and egress areas for domestic animals utilizing an independent illumination system that is not integrated into a unit intended for walking, running, trotting, exercising, laying, standing, sitting, sleeping, feeding, egressing, defecating, urinating, dwelling, or kenneling.

Another aspect of the invention can be to provide illumination of path, task, and egress areas for domestic animals utilizing an illumination system integrated into a unit intended for walking, running, trotting, exercising, laying, standing, sitting, sleeping, feeding, egressing, defecating, urinating, dwelling, or kenneling.

An aspect of the invention can be to provide illumination of path, task, and egress areas for domestic animals utilizing a solar powered system to charge the energy supply for said illumination system.

An aspect of the invention can be to provide illumination of path, task, and egress areas for domestic animals utilizing a battery powered system to provide energy to said illumination system.

An aspect of the invention can be to provide illumination of path, task, and egress areas for domestic animals utilizing a plug-in powered system to provide energy to said illumination system.

An aspect of the invention can be to provide illumination of path, task, and egress areas for domestic animals utilizing an illumination system designed to avoid directing light toward the eye level of the domestic animal by adjusting the height, light dispersion, or light angle of said illumination system.

An aspect of the invention can be to provide the illumination of path, task, and egress areas, prior to the domestic animal entering said area, when the motion of the domestic animal is detected in a different path, task, or egress areas.

### BRIEF DESCRIPTION OF THE DRAWINGS

The present invention is illustrated by way of example and not limitation in the figures of the accompanying drawings in which like references indicate similar elements.

FIG. 1 Shows various embodiments of the motion activated illumination system to facilitate task illumination for domestic animals.

FIG. 2 Shows various embodiments of the motion activated illumination system to facilitate egress into or out of a structure for domestic animals.

FIG. 3 Shows various embodiments of the motion activated illumination system to facilitate task illumination for domestic animal's urination or defecation enclosure.

FIG. 4 Shows various embodiments of the motion activated illumination system to facilitate task or path illumination for domestic animals inside a kennel or enclosure.

FIG. 5 Shows various embodiments of the motion activated illumination system to facilitate path illumination for domestic animals.

FIG. 6A Shows various embodiments of the motion activated illumination system to facilitate path illumination for domestic animals which is ceiling oriented and not integrated into a unit, component, or structure.

FIG. 6B Shows various embodiments of the motion activated illumination system to facilitate path illumination for domestic animals which is ceiling oriented and integrated into a unit, component, or structure.

FIG. 6C Shows various embodiments of the motion activated illumination system to facilitate path illumination for domestic animals which is wall oriented and not integrated into a unit, component, or structure.

FIG. 6D Shows various embodiments of the motion activated illumination system to facilitate path illumination for domestic animals which is wall oriented and integrated into a unit, component, or structure.

FIG. 7 Shows various embodiments of the motion activated illumination system to facilitate path or egress illumination, prior to the domestic animal entering said area, when the motion of the domestic animal is detected in a different path or egress area.

### DETAILED DESCRIPTION OF THE PREFERRED EMBODIMENTS

A motion activated illumination system to facilitate task and path illumination for domestic animals.

While various embodiments of the invention are illustrated or described for use in commonly known domestic animal walking, running, trotting, exercising, laying, standing, sleeping, sitting, feeding, egressing, defecating, urinating, kenneling areas or the like, the particular examples of path and task areas are not meant to limit the scope of the invention to these examples but rather the examples are meant to be illustrative of how to implement various embodiments of the invention to provide illumination for domestic animals.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions. Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

An embodiment of the invention, as shown and described by the various figures and accompanying text, provides a domestic animal illumination system and method optimized for sustainable use for enhancing the life of domestic animals.

An embodiment of the invention includes a method of generating light in path and task areas for domestic animals. One or more light emitting elements are energized thereby generating primary illumination over a target area. The response of domestic animals to various wavelengths of light differs depending on the ambient light conditions. This varying response is at least partially due to the two basic light-receptive structures in the eye, rods and cones. Cones tend to be more active in brightly-lit ambient conditions, whereas rods are more active in dimly-lit ambient conditions. Cones are generally regarded as more sensitive to color differences whereas rods are more sensitive to the absence or presence of light. This is why domestic animals with more acute night vision, such as cats and dogs, have eyes containing a relatively greater proportion of rods allowing them to see in low light conditions. This does not however allow them to see in total darkness. Because of this misconception, on the part of their caretakers, many domestic animals succumb to move and function in total darkness for which they have decreased ability. Orientation of the motion activated illumination systems in specific areas to facilitate task and path illumination will allow domestic animals to move more freely and safely in dark areas of their habitat.

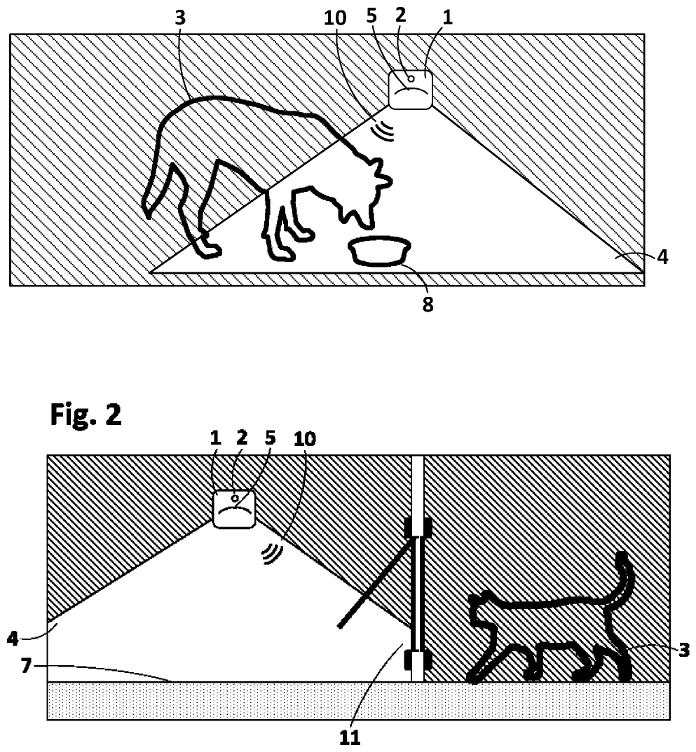

Now referring primarily to FIG. 1, which provides an example of basic embodiments of the invention can further include task (8) illumination with a motion activated (10) illumination system (1) utilizing a light sensor (5) and motion sensor (2) to actuate light dispersion (4) to facilitate task (8) illumination for purpose such as laying, standing, sleeping, sitting, feeding, egressing, defecating, urinating, and kenneling areas for domestic animals (3).

Now referring primarily to FIG. 2, a particular embodiment of the invention can further include egress (11) illumination with a motion activated (10) illumination system (1) utilizing a light sensor (5) and motion sensor (2) to actuate light dispersion (4) to facilitate path (7) illumination for purposes such as egress (11) through domestic animal access doors, kennel runways, tunnels or other contrivances used to move to or from dwellings, buildings, sheds or kennels for domestic animals (3).

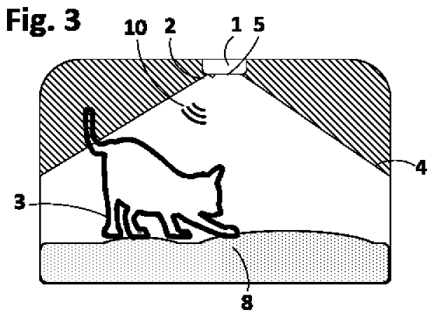

Now referring primarily to FIG. 3, a particular embodiment of the invention can further include task (8) area illumination with a motion activated (10) illumination system (1) utilizing a light sensor (5) and a motion sensor (2) to actuate light dispersion (4) to facilitate task (8) illumination for urination and defecation purposes, such as litter boxes, for domestic animals (3).

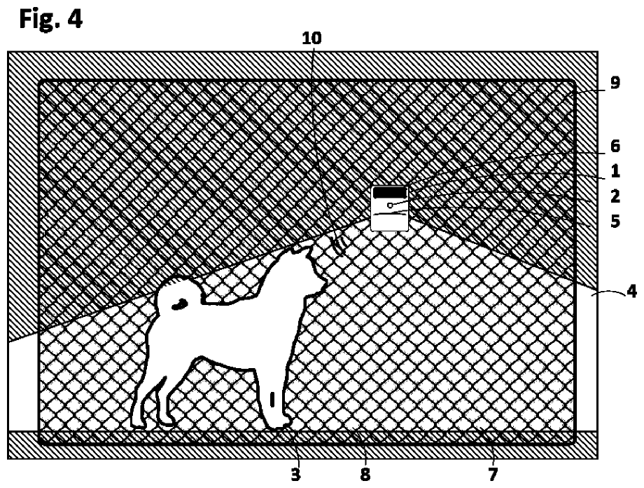

Now referring primarily to FIG. 4, a particular embodiment of the invention can further include path (7) and task (8) illumination with a motion activated (10) solar powered (6) illumination system (1) utilizing a light sensor (5) and motion sensor (2) to actuate light dispersion (4) to facilitate path (7) and task (8) illumination for kennel areas (9) for purposes such as walking, trotting, running, exercising, laying, standing, sleeping, sitting, feeding, egressing, defecating, urinating, and kenneling areas for domestic animals (3).

Now referring primarily to FIG. 5, a particular embodiment of the invention can further include path (7) illumination with a motion activated (10) illumination system (1) utilizing a light sensor (5) and motion sensor (2) to actuate light dispersion (4) to facilitate path (7) illumination for purposes such as walking, trotting, running, or transitioning areas, for domestic animals (3).

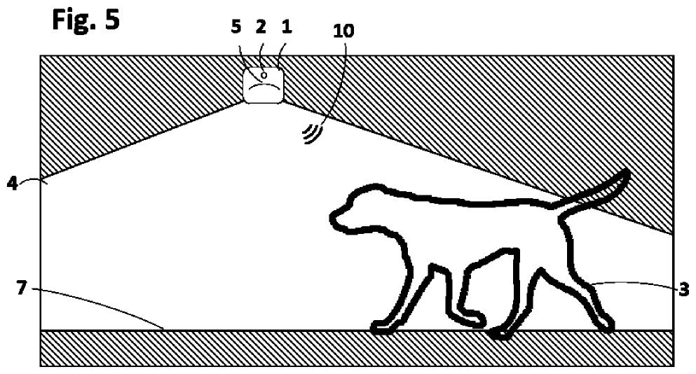

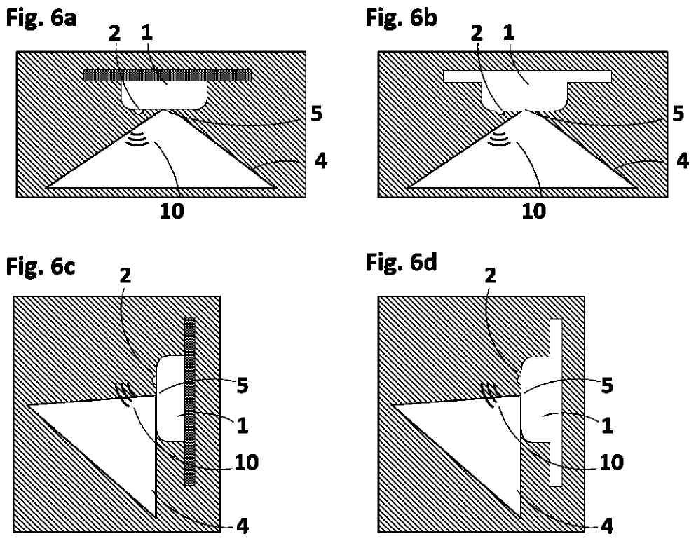

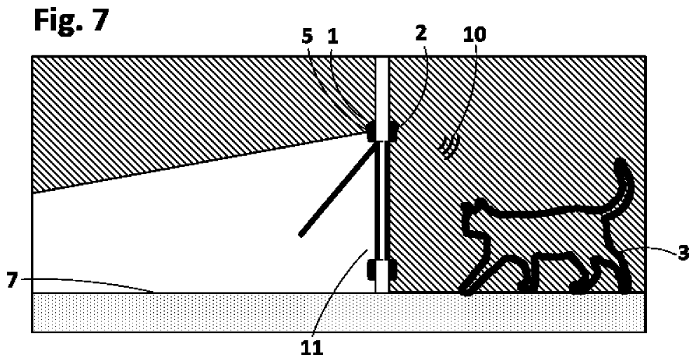

Now referring primarily to FIG. 6A, a particular embodiment of the invention can further illustrate a domestic animal illumination system (1) that is ceiling oriented and not integrated into a unit, component or structure, utilizing a motion sensor (2) and light sensor (5), to actuate light dispersion (4).

Now referring primarily to FIG. 6B, a particular embodiment of the invention can further illustrate a domestic animal illumination system (1) that is ceiling oriented and integrated into a unit, component or structure, utilizing a motion sensor (2) and light sensor (5), to actuate a light dispersion (4).

Now referring primarily to FIG. 6C, a particular embodiment of the invention can further illustrate a domestic animal illumination system (1) that is wall oriented and not integrated into a unit, component or structure, utilizing a motion sensor (2) and light sensor (5), to actuate a light dispersion (4).

Now referring primarily to FIG. 6D, a particular embodiment of the invention can further illustrate a domestic animal illumination system (1) that is wall oriented and integrated into a unit, component or structure, utilizing a motion sensor (2) and light sensor (5), to actuate a light dispersion (4).

Now referring primarily to FIG. 7, a particular embodiment of the invention can further include path (7) and egress (11) illumination with a motion activated (10) illumination system (1) utilizing a light sensor (5) and motion sensor (2) to actuate light dispersion (4) to illuminate different paths (7) or egress (11) areas, prior to the domestic animal (3) entering said area, when the motion of the domestic animal (3) is detected in a different path (8) or egress (11) area.

1) A method of facilitating illumination for domestic animals, comprising steps of; a. light sensor detecting an ambient light level; and b. motion sensor detecting domestic animal movement; and c. actuation of an illumination system.

2) A method of facilitating illumination for domestic animals as described in claim 1, wherein the light sensor detects a low ambient light level and the illumination system is activated.

3) A method of facilitating illumination for domestic animals as described in claim 1, wherein the light sensor detects a high ambient light level and the illumination system is deactivated.

4) A method of facilitating illumination for domestic animals as described in claim 1, wherein the motion sensor detects domestic animal movement and the illumination system is activated.

5) A method of facilitating illumination for domestic animals as described in claim 1, wherein the motion sensor detects no domestic animal movement and the illumination system is deactivated.

6) A method of facilitating illumination for domestic animals as described in claim 1, wherein said illumination system provides illumination of path, task, and egress areas for domestic animals.

7) A method of facilitating illumination for domestic animals as described in claim 1, wherein said illumination system is integrated into a unit intended for walking, running, trotting, exercising, laying, standing, sitting, sleeping, feeding, egressing, defecating, urinating, dwelling, or kenneling for domestic animals.

8) A method of facilitating illumination for domestic animals as described in claim 1, wherein said illumination system is independently mounted and not integrated into a unit intended for walking, running, trotting, exercising, laying, standing, sitting, sleeping, feeding, egressing, defecating, urinating, dwelling, or kenneling for domestic animals.

9) A method of facilitating illumination for domestic animals as described in claim 1, wherein said illumination system provides illumination utilizing a light frequency within the light spectrum of 550-740(nm) so as to not disrupt domestic animal melatonin production.

10) A method of facilitating illumination for domestic animals as described in claim 1, wherein said illumination system provides illumination utilizing a light frequency within the light spectrum of 320-549(nm) so as to activate domestic animal melatonin production.

11) A method of facilitating illumination for domestic animals as described in claim 1, wherein a solar power system is utilized to charge an energy supply for said illumination system.

12) A method of facilitating illumination for domestic animals as described in claim 1, wherein a plug-in system is utilized to power said illumination system.

13) A method of facilitating illumination for domestic animals as described in claim 1, wherein a battery system is utilized to power said illumination system.

14) A method of facilitating illumination for domestic animals as described in claim 1, further comprising the step of utilizing an illumination system designed to avoid directing light toward the eye level of the domestic animal by adjusting the height, light dispersion, or light angle of said illumination system.

15) A method of facilitating illumination for domestic animals as described in claim 6, further comprising activating an illumination system prior to the domestic animal entering said areas, when the motion of the domestic animal is detected in a different path, task, or egress areas.
